(19) United States
(12) Patent Application Publication
(10) Pub. No.: US 2012/0280900 A1
(43) Pub. Date: Nov. 8, 2012

(54) GESTURE RECOGNITION USING PLURAL SENSORS

(75) Inventors: Kong Qiao Wang, Beijing (CN); Jani Petri Juhani Ollikainen, Helsinki (FI)

(73) Assignee: Nokia Corporation

(21) Appl. No.: 13/102,658

(22) Filed: May 6, 2011

(51) Int. Cl. G09G 5/00

(52) U.S. Cl. 345/156

(57) ABSTRACT

Apparatus comprises a processor; a user interface enabling user interaction with one or more software applications associated with the processor; first and second sensors configured to detect, and generate signals corresponding to, objects located within respective first and second sensing zones remote from the apparatus, wherein the sensors are configured such that their respective sensing zones overlap spatially to define a third, overlapping, zone in which both the first and second sensors are able to detect a common object; and a gesture recognition system for receiving signals from the sensors, the gesture recognition system being responsive to detecting an object inside the overlapping zone to control a first user interface function in accordance with signals received from both sensors.

### FIELD OF THE INVENTION

This invention relates generally to gesture recognition and, particularly, though not exclusively, to recognising gestures detected by first and second sensors of a device or terminal.

### BACKGROUND TO THE INVENTION

It is known to use video data received by a camera of a communications terminal to enable user control of applications associated with the terminal. Applications store mappings relating predetermined user gestures detected using the camera to one or more commands associated with the application. For example, a known photo-browsing application allows hand-waving gestures made in front of a terminal's front-facing camera to control how photographs are displayed on the user interface, a right-to-left gesture typically resulting in the application advancing through a sequence of photos.

However, cameras tend to have a limited optical sensing zone, or field-of-view, and also, because of the way in which they operate, they have difficulty interpreting certain gestures, particularly ones involving movement towards or away from the camera. The ability to interpret three-dimensional gestures is therefore very limited.

Further, the number of functions that can be controlled in this way is limited by the number of different gestures that the system can distinguish.

In the field of video games, it is known to use radio waves emitted by a radar transceiver to identify object movements over a greater ‘field-of-view’ than a camera.

### SUMMARY OF THE INVENTION

A first aspect of the invention provides apparatus comprising:
a processor;
a user interface enabling user interaction with one or more software applications associated with the processor;
first and second sensors configured to detect, and generate signals corresponding to, objects located within respective first and second sensing zones remote from the apparatus, wherein the sensors are configured such that their respective sensing zones overlap spatially to define a third, overlapping, zone in which both the first and second sensors are able to detect a common object; and
a gesture recognition system for receiving signals from the sensors, the gesture recognition system being responsive to detecting an object inside the overlapping zone to control a first user interface function in accordance with signals received from both sensors.

The gesture recognition system may be further responsive to detecting an object outside of the overlapping zone to control a second, different, user interface function in accordance with a signal received from only one of the sensors.

The gesture recognition system may be further responsive to detecting an object inside the overlapping zone to identify from signals received from both sensors one or more predetermined gestures based on detected movement of the object, and to control the first user interface function in accordance with each identified gesture.

The first sensor may be an optical sensor and the second sensor may sense radio waves received using a different part of the electromagnetic spectrum, and optionally is a radar sensor. The appararus may further comprise image processing means associated with the optical sensor, the image processing means being configured to identify image signals received from different regions of the optical sensor, and wherein the gesture recognition system is configured to control different respective user interface functions dependent on the region in which an object is detected. The radar sensor may be configured to emit and receive radio signals in such a way as to define a wider spatial sensing zone than a spatial sensing zone of the optical sensor. The gesture recognition system may be configured to identify, from the received image and radio sensing signals, both a translational and a radial movement and/or radial distance for an object with respect to the apparatus and to determine therefrom the one or more predetermined gestures for controlling the first user interface function. The gesture recognition system may be configured to identify, from the received image signal, a motion vector associated with the foreground object's change of position between subsequent image frames and to derive therefrom the translational movement.

The apparatus may be a mobile communications terminal. The mobile communications terminal may comprise a display on one side or face thereof for displaying graphical data controlled by means of signals received from both the first and second sensors. The optical sensor may be a camera provided on the same side or face as the display. The radar sensor may be configured to receive reflected radio signals from the same side or face as the display.

The gesture recognition system may be configured to detect a hand-shaped object.

A second aspect of the invention provides a method comprising:
receiving signals from first and second sensors, the first and second sensors having respective first and second object sensing zones and providing a third, overlapping, zone in which both the first and second sensors can detect a common object, and
in response to detecting an object in the overlapping zone, controlling a first user interface function in accordance with the signals received from both sensors.

The method may further comprise receiving, in response to detecting an object outside of the overlapping zone, a signal from only one of the sensors; and controlling a second, different, user interface function in accordance with said received signal.

The method may further comprise receiving, in response to detecting an object outside of the overlapping zone, a signal from only the second sensor; and controlling a third, different, user interface function in accordance with said received signal.

The method may further comprise identifying from signals received from both sensors one or more predetermined gestures based on detected movement of the object, and controlling the first user interface function in accordance with the or each identified gesture.

The method may further comprise identifying image signals received from different regions of an optical sensor, and controlling different respective user interface functions dependent on the region in which an object may be detected.

A third aspect of the invention provides a computer program comprising instructions that when executed by a computer apparatus control it to perform a method above

A fourth aspect of the invention provides a non-transitory computer-readable storage medium having stored thereon computer-readable code, which, when executed by computing apparatus, causes the computing apparatus to perform a method comprising:
receiving signals from first and second sensors, the first and second sensors having respective first and second object sensing zones and providing a third, overlapping, zone in which both the first and second sensors can detect a common object, and
in response to detecting an object in the overlapping zone, controlling a first user interface function in accordance with the signals received from both sensors.

A fifth aspect of the invention provides apparatus, the apparatus having at least one processor and at least one memory having computer-readable code stored thereon which when executed controls the at least one processor:
to receive signals from first and second sensors, the first and second sensors having respective first and second object sensing zones and providing a third, overlapping, zone in which both the first and second sensors can detect a common object, and
to respond to detecting an object in the overlapping zone by controlling a first user interface function in accordance with the signals received from both sensors.

### BRIEF DESCRIPTION OF THE DRAWINGS

Embodiments of the present invention will now be described, by way of example only, with reference to the accompanying drawings, in which:

FIG. 1 is a perspective view of a mobile terminal embodying aspects of the invention;

FIGS. 2a and 2b are circuit diagrams of different examples of radar sensor types that can be used in the mobile terminal shown in FIG. 1;

FIG. 3 is a schematic diagram illustrating components of the FIG. 1 mobile terminal and their interconnection;

FIGS. 4a and 4b are schematic diagrams of the mobile terminal of FIG. 1 shown with respective sensing zones for first and second sensors, including an overlapping zone;

FIG. 5 is a schematic diagram illustrating functional components of a gesture control module provided as part of the mobile terminal shown in FIG. 1;

FIG. 6 shows a control map which relates signature data from sensors to one or more control functions for software associated with the terminal shown in FIG. 1;

FIGS. 7a, 7b and 7c show graphical representations of how various control functions may be employed, which are useful for understanding the invention; and

FIG. 8 is a schematic diagram of a second embodiment of a mobile terminal in which a camera sensor is divided into a plurality of sensing zones.

### DETAILED DESCRIPTION OF PREFERRED EMBODIMENTS

Embodiments described herein comprise a device or terminal, particularly a communications terminal, which uses complementary sensors to provide information characterising the environment around the terminal. In particular, the sensors provide information which is processed to identify an object in respective sensing zones of the sensors, and the object's motion, to identify a gesture.

Depending on whether an object is detected by just one sensor or both sensors, a respective command, or set of commands, is or are used to control a user interface function of the terminal, for example to control some aspect of the terminal's operating system or an application associated with the operating system. Information corresponding to an object detected by just one sensor is processed to perform a first command, or a first set of commands, whereas information corresponding to an object detected by two or more sensors is processed to perform a second command, or a second set of commands. In the second case, this processing is based on a fusion of the information from the different sensors.

Furthermore, the information provided by the sensors can be processed to identify a user gesture based on movement of an object sensed by one or both sensors. Thus, a particular set of commands to be performed is dependent on which sensor or sensors detect the gesture and, further, by identifying particular gestures which correspond to different commands within the set.

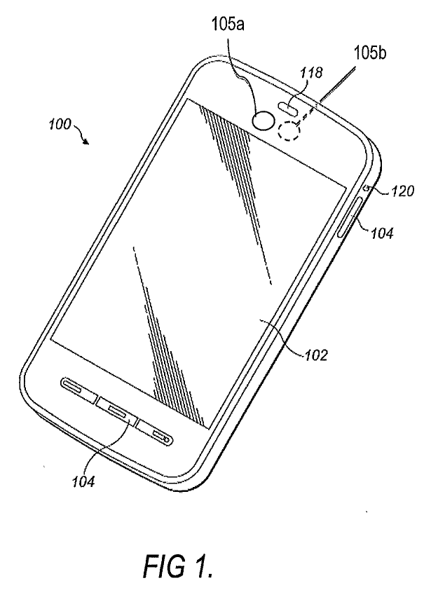

Referring firstly to FIG. 1, a terminal 100 is shown. The exterior of the terminal 100 has a touch sensitive display 102, hardware keys 104, a front camera 105a, a radar sensor 105b, a speaker 118 and a headphone port 120. The radar sensor 105b may be internal and thus not visible on the exterior of the terminal 100. The terminal 100 may be a smartphone, a mobile phone, a personal digital assistant, a tablet computer, laptop computer, etc. The terminal 100 may instead be a non-portable device such as a television or a desktop computer. A non-portable device is a device that requires a connection to mains power in order to function.

The front camera 105a is provided on a first side of the terminal 100, that is the same side as the touch sensitive display 102.

The radar sensor 105b is provided on the same side of the terminal as the front camera 105a, although this is not essential. The radar sensor 105b could be provided on a different, rear, side of the terminal 100. Alternatively still, although not shown, there may be a rear camera 105 provided on the rear side of the terminal 100 together with the radar sensor 105b

As will be appreciated, radar is an object-detection system which uses electromagnetic waves, specifically radio waves, to detect the presence of objects, their speed and direction of movement as well as their range from the radar sensor 105b. Emitted waves which bounce back, i.e. reflect, from an object are detected by the sensor. In sophisticated radar systems, a range to an object can be determined based on the time difference between the emitted and reflected waves. In simpler systems, the presence of an object can be determined but a range to the object cannot. In either case, movement of the object towards or away from the sensor 105b can be detected through detecting a Doppler shift. In sophisticated systems, a direction to an object can be determined by beamforming, although direction-finding capability is absent in systems that are currently most suitable to implementation in handheld devices.

A brief description of current radar technology and its limitations now follows. In general, a radar can detect presence, radial speed and direction of movement (towards or away), or it can detect the range of the object from the radar sensor. A very simple Doppler radar can detect only the speed of movement. If a Doppler radar has quadrature downconversion, it can also detect the direction of movement. A pulsed Doppler radar can measure the speed of movement. It can also measure range. A frequency-modulated continuous-wave (FMCW) radar or an impulse/ultra wideband radar can measure a range to an object and, using a measured change in distance in time, also the speed of the movement. However, if only speed measurement is required, a Doppler radar is likely to be the most suitable device. It will be appreciated that a Doppler radar detects presence from movement whereas FMCW or impulse radar detect it from the range information.

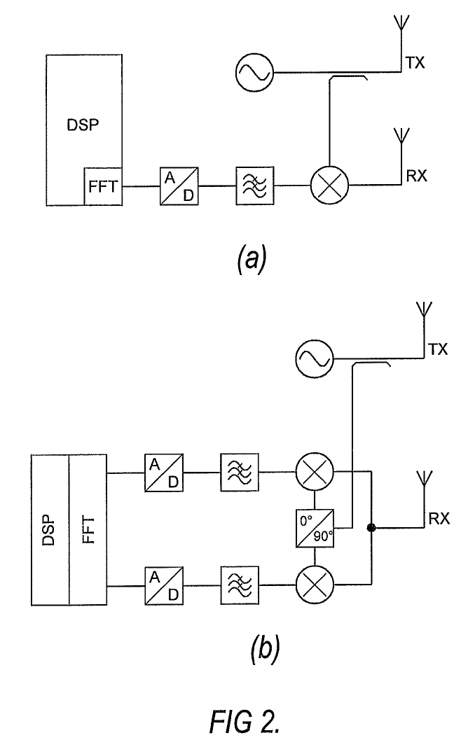

Here, the radar sensor 105b comprises both the radio wave emitter and detector parts and any known radar system suitable for being located on a hand-held terminal can be employed. FIGS. 2a and 2b illustrate the general principle of operation using, respectively, a Doppler radar front-end and a Doppler radar front-end with quadrature downconversion. Both examples include analogue-to-digital (ADC) conversion means and Fast Fourier Transform (FFT) and Digital Signal Processing (DSP) means for converting and processing the reflected wave information into digital signals indicative of the radial direction of an object's motion, i.e. towards and away from the radar sensor 105b, based on IQ phase information. Also, the Doppler radar system disclosed in U.S. Pat. No. 6,492,933 may be used and arranged on the terminal 100.

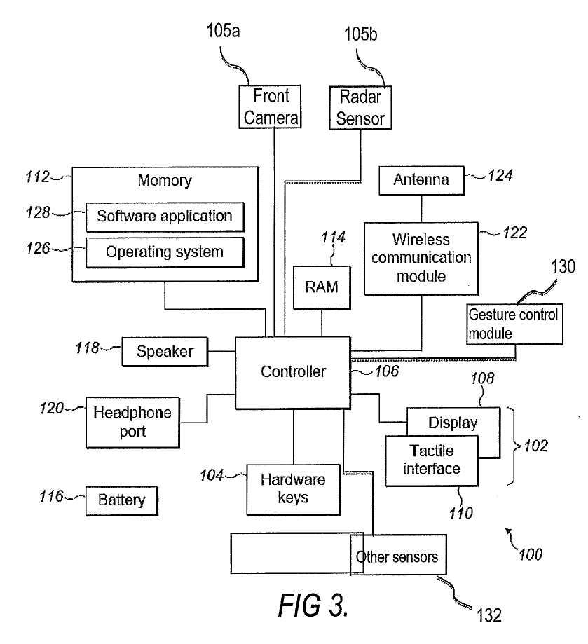

FIG. 3 shows a schematic diagram of selected components of the terminal 100. The terminal 100 has a controller 106, a touch sensitive display 102 comprised of a display part 108 and a tactile interface part 110, the hardware keys 104, the front camera 105a, the radar sensor 105b, a memory 112, RAM 114, a speaker 118, the headphone port 120, a wireless communication module 122, an antenna 124, and a battery 116.

Further, a gesture control module 130 is provided for processing data signals received from the camera 105a and the radar sensor 105b to identify a command or set of commands for gestural control of a user interface of the terminal 100. In this context, a user interface means any input interface to software associated with the terminal 100.

Further still, other sensors, indicated generally by box 132, are provided as part of the terminal 100. These include one or more of an accelerometer, gyroscope, microphone, ambient light sensor and so on. As will be described later on, information derived from such other sensors can be used to adjust weightings in the aforementioned gesture control module 130, and can also be used for detecting or aiding gesture detection, or even enabling or disabling gesture detection.

The controller 106 is connected to each of the other components (except the battery 116) in order to control operation thereof.

The memory 112 may be a non-volatile memory such as read only memory (ROM) a hard disk drive (HDD) or a solid state drive (SSD). The memory 112 stores, amongst other things, an operating system 126 and may store software applications 128. The RAM 114 is used by the controller 106 for the temporary storage of data. The operating system 126 may contain code which, when executed by the controller 106 in conjunction with RAM 114, controls operation of each of the hardware components of the terminal.

The controller 106 may take any suitable form. For instance, it may be a microcontroller, plural microcontrollers, a processor, or plural processors.

The terminal 100 may be a mobile telephone or smartphone, a personal digital assistant (PDA), a portable media player (PMP), a portable computer or any other device capable of running software applications and providing audio and/or video outputs. In some embodiments, the terminal 100 may engage in cellular communications using the wireless communications module 122 and the antenna 124. The wireless communications module 122 may be configured to communicate via several protocols such as GSM, CDMA, UMTS, Bluetooth and IEEE 802.11 (Wi-Fi).

The display part 108 of the touch sensitive display 102 is for displaying images and text to users of the terminal and the tactile interface part 110 is for receiving touch inputs from users.

As well as storing the operating system 126 and software applications 128, the memory 112 may also store multimedia files such as music and video files. A wide variety of software applications 128 may be installed on the terminal including web browsers, radio and music players, games and utility applications. Some or all of the software applications stored on the terminal may provide audio outputs. The audio provided by the applications may be converted into sound by the speaker(s) 118 of the terminal or, if headphones or speakers have been connected to the headphone port 120, by the headphones or speakers connected to the headphone port 120.

In some embodiments the terminal 100 may also be associated with external software application not stored on the terminal. These may be applications stored on a remote server device and may run partly or exclusively on the remote server device. These applications can be termed cloud-hosted applications. The terminal 100 may be in communication with the remote server device in order to utilise the software application stored there. This may include receiving audio outputs provided by the external software application.

In some embodiments, the hardware keys 104 are dedicated volume control keys or switches. The hardware keys may for example comprise two adjacent keys, a single rocker switch or a rotary dial. In some embodiments, the hardware keys 104 are located on the side of the terminal 100.

The camera 105a is a digital camera capable of generating image data representing a scene received by the camera's sensor. The image data can be used to capture still images using a single frame of image data or to record a succession of frames as video data.

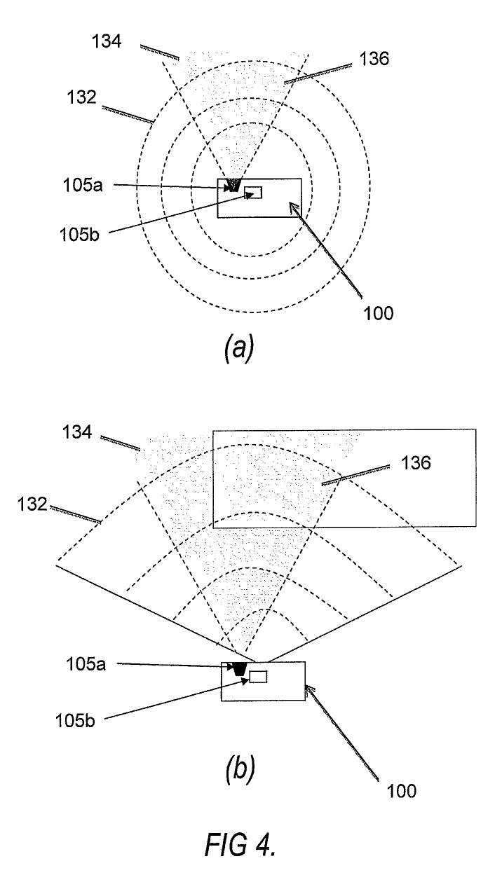

Referring to FIGS. 4a and 4b, the camera 105a and radar sensor 105b have respective sensing zones 134, 132. In the case of the radar sensor 105b, the sensing zone 132 is the spatial volume, remote from the terminal 100, from which emitted radio waves can be reflected and detected by the sensor. In the case of FIG. 4a, the radar sensor 105b emits, and detects, radio waves from all around the terminal 100, defining effectively an isotropic sensing zone 132. In FIG. 4b, the radar's sensing zone 132 is more focussed, in particular having a field of view of less than half of the isotropic sensing zone. In the case of the camera 105a, the sensing zone is its generally-rectangular field-of-view within which optical waves reflecting from or emitted by objects are detected by the camera's light sensors.

The camera 105a and radar sensor 105b therefore operate in different bands of the electromagnetic spectrum. The camera 105a in this embodiment detects light in the visible part of the spectrum, but can also be an infra-red camera.

The camera 105a and radar sensor 105b are arranged on the terminal 100 such that their respective sensing zones overlap to define a third, overlapping zone 136 in which both sensors can detect a common object. The overlap is partial in that the radar sensor's sensing zone 132 extends beyond that of the camera's 134 in terms of it's radial spatial coverage, as indicated in FIGS. 4a and 4b which both show a side view of the terminal 100. Where the range of the radar sensor's sensing zone 132 is limited, it is possible that the camera's optical range, that is the maximum distance from which it can detect objects, extends beyond that of the radar's. Also, the camera's sensing zone 134 may be wider than that of a more focussed radar sensor 105b.

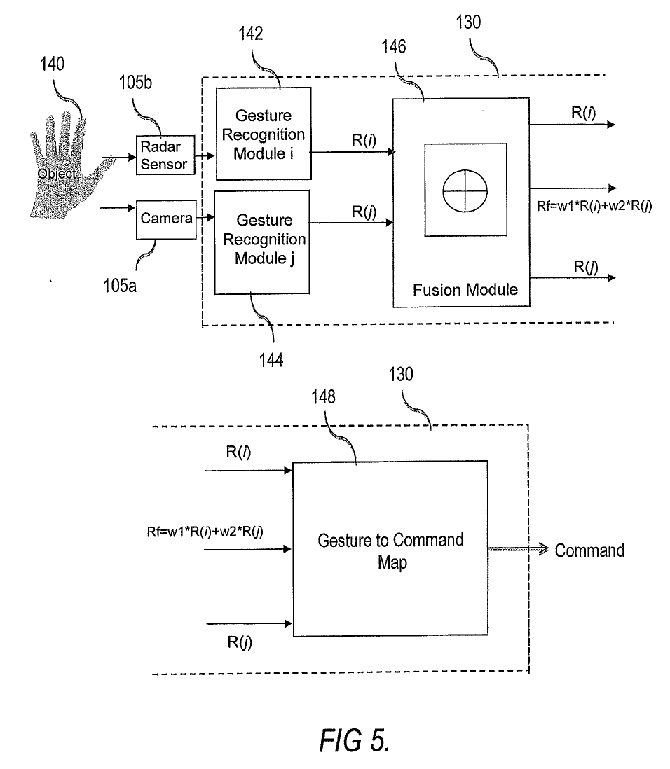

Referring to FIG. 5, components of the gesture control module 130 are shown.

The gesture control module 130 comprises first and second gesture recognition modules (i, j) 142, 144 respectively associated with the radar sensor 105b and camera 105a.

The first gesture recognition module 142 receives digitised data from the radar sensor 105b (see FIG. 2) from which can be derived signature information pertaining to (i) the presence of an object 140 within sensing zone 132, (ii) optionally, the radial range of the object with respect to the sensor and (iii) the motion of the object, including the speed and direction of movement, based on a detected Doppler shift. Collectively, this signature information is referred to as R(i) which can be used to identify one or more predetermined user gestures, made remotely of the terminal 100 within the radar's sensing zone 132. This can be performed by comparing the derived information R(i) with reference information Ref(i) which relates R(i) to predetermined reference signatures for different gestures.

The second gesture recognition module 144 receives digitised image data from the camera 105a from which can be derived signature information pertaining to the presence, shape, size and motion of an object 140 within its sensing zone 134. The motion of an object 140 can be its translational motion based on the change in the object's position with respect to horizontal and vertical axes (x, y). The motion of an object 140 to or from the camera 105a (comparable to its range from the terminal 100) can be estimated based on the change in the object's size over time. Collectively, this signature information is referred to as R(j) which can be used to identify one or more predetermined user gestures, made remotely of the terminal 100 within the camera's sensing zone 134. This can be performed by comparing the derived signature information R(j) with reference information Ref(j) which relates R(j) to predetermined reference signatures for different gestures.

The gesture control module 130 further comprises a fusion module 146 which takes as input both R(i) and R(j) and generates a further set of signature information R(f) based on a fusion of both R(i) and R(j). Specifically, the fusion module 146 detects from R(i) and R(j) when an object 140 is detected in the overlapping zone 136, indicated in FIGS. 4a and 4b. If so, it generates the further, fusion signature R(f), equating to w1*R(i)+w2*R(j) where w1 and w2 are weighting factors. Again, R(f) can be compared with reference information Ref(f) which relates R(f) to predetermined reference signatures for different gestures.

The reference information Ref(i), (j) and (f) may be entered into the gesture control module 130 in the product design phase, but new multimodal gestures can be taught and stored in the module.

It will be appreciated that the fusion signature R(f) can provide a more accurate gesture recognition based on a collaborative combination of data from both the camera 105a and the radar sensor 105b. For example, whereas the camera 105a has limited capability for accurately determining whether an object is moving radially, i.e. towards or away from the terminal 100, data received from the radar sensor 105b can provide an accurate indication of radial movement. However, the radar sensor 105b does not have the ability to identify accurately the shape and size of the object 140; image data received from the camera 105a can be processed to achieve this with high accuracy. Also, the radar sensor 105b does not have the ability to identify accurately translational movement of the object 140, i.e. movement across the field of view of the radar sensor 105b, although image data received from the camera 105a can be processed to achieve this with high accuracy.

The weighting factors w1, w2 can be used to give greater significance to either signature to achieve greater accuracy in terms of identifying a particular gesture. For example, if both signatures R(i) and R(j) indicate radial movement with respect to the terminal 100, a greater weighting can be applied to R(i) given radar's inherent ability to accurately determine radial movement compared with the camera's. The weighting factors w1, w2 can be computed automatically based on a learning algorithm which can detect information such as the surrounding illumination, device vibration and so on using information relating to user context. For example, the abovementioned use of one or more of an accelerometer, gyroscope, microphone and light sensor (as envisaged in box 132 of FIG. 3) can provide information to adjust weightings in the aforementioned gesture control module 130, and can also be used for detecting or aiding gesture detection, or even enabling or disabling gesture detection.

Furthermore, by identifying if the object 140 is in or outside the overlapping zone 136, common or similar gestures can be assigned to different user interface functions.

The signatures R(i), R(j) and R(f) are output to a gesture-to-command map (hereafter “command map”) 148, to be described below.

The purpose of the command map 148 is to identify to which command the received signature, be it R(i), R(j) or R(f), corresponds. The identified command is then output to the controller 106 in order to control software associated with the terminal 100.

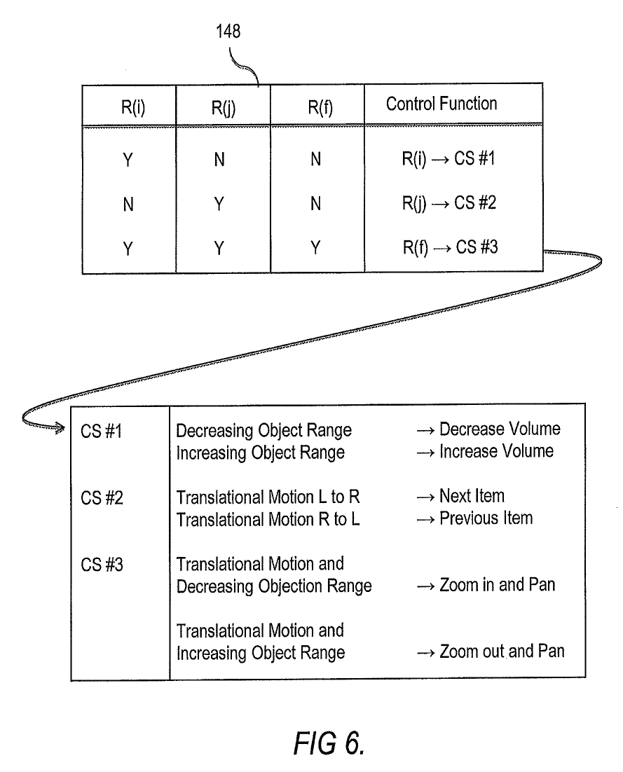

Referring to FIG. 6, a simplified command map 148 is shown. Here, it is assumed that ethree sets of interface control functions are enabled for remote gestural control, respectively labelled CS#1, CS#2 and CS#3.

In the case where an object is detected within the radar sensing zone 132 only, the radar signature R(i) is used to control CS#1. Similarly, in the case where an object is detected within the camera sensing zone 134 only, the camera signature R(j) is used to control CS#2. Where an object is detected within the overlapping zone 136, the fusion signature R(f) is used to control CS#3.

Within each set, CS#2, CS#2, CS#3, the particular gesture identified is used to control further characteristics of the interface control function.

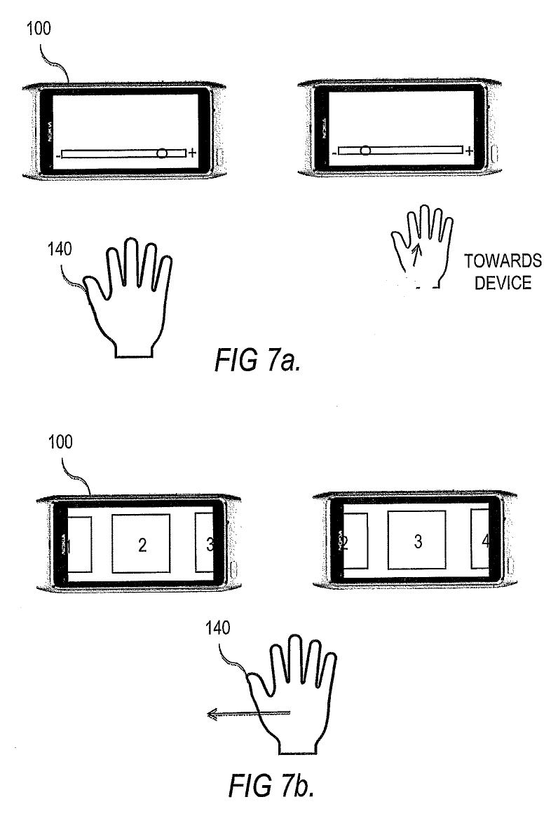

Taking practical examples, CF#1 relates to a volume control command, where the presence of an object 140 only in the radar sensing zone 132 enables a volume control. In this case, as the object moves, the volume control is increased and decreased in response to a respective increase and decrease in the object's range. FIG. 7a indicates the principle of operation graphically.

In principle, there are a number of ways of using range to control volume. For example, the volume level may depend on the measured range of the object from the device. Alternatively, as with the situation shown in FIG. 7a, the volume level is increased and decreased based on whether movement is respectively towards and way the device (based on Doppler or range v. time). The rate of change in volume can depend on the speed of the movement. The second, Doppler, option is easier to implement. In both cases there is the need to provide a way of allowing the user's hand to move away from the device once a desired volume level is set. This can be achieved by enabling the control by pressing a button or by touching the terminal 100 in a certain way. One option is that the volume control is enabled only when radar 105b detects movement and at the same time the camera 105a detects the object in its viewing zone 134. Another option is to freeze the level after the object has been held still for a certain time period (e.g. 3 seconds).

CF#2 relates to a GUI selection scroll command, where the presence of an object 140 only in the camera sensing zone 134 enables a selection cursor. As the object moves in the field-of-view, the cursor moves between selectable items, e.g. between application icons on a desktop or photographs on a photo-browsing application. FIG. 7b indicates the principle of operation graphically.

CF#3 may relate to a three-dimensional GUI interaction command where the presence of an object 140 in the overlapping zone 136 causes both translational motion in X-Y space, combined with a zoom in/out operation based on radial movement of the object. The zoom operation may take information received from both the camera 105a and the radar sensor 105b but, as indicated previously, the signature received from the radar sensor is likely to be weighted higher. FIG. 7c indicates the principle of operation graphically.

CF#3 may also cater for situations where there is radial movement but there is no translational motion, for example to control zoom-in and -out functions without translation on the GUI, and vice versa.

Other gestures that can be identified through the command map include those formed by sequential movements. For example, the sequence of (i) radial movement away from the device (detected using radar 105b), (ii) right to left translational motion (detected using the camera 105a), (iii) radial movement towards the device (detected using radar) and (iv) left to right translational motion (detected using the camera) could be interpreted to correspond with a counter clockwise rotation for the user interface. Other such sequential gestures can be catered for.

The gesture control module 130 can be embodied in software, hardware or a combination of both.

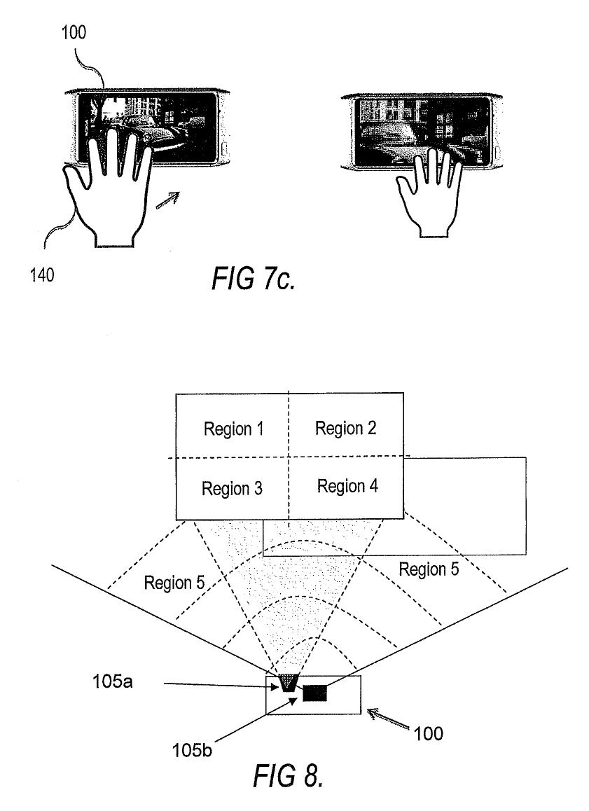

A second embodiment of the invention will now be described with reference to FIG. 8. In this embodiment, the field-of-view of camera 105a is effectively divided into two or more sub-regions N, in this case four sub-regions. More particularly, processing software associated with the camera 105a assigns respective groups of pixels to the different sub-regions N. Objects detected in different ones of the N sub-regions are assigned to different user interface functions in the same way as for the first embodiment, with objects detected outside of the radar/camera overlapping region being assigned to a further function. Thus, the number of user interface functions that can be conveniently distinguished using gestures is further increased.

The aforementioned object 140 is presumed to be a human hand, although fingers, pointers or other user-operable objects could be identified by the camera 105a and radar sensor 105b as a recognizable object. Other suitable objects include a human head, a foot, glove or shoe. The system could also operate so that it is the terminal 100 that is moved relative to a stationary object.

It will be appreciated that the above described embodiments are purely illustrative and are not limiting on the scope of the invention. Other variations and modifications will be apparent to persons skilled in the art upon reading the present application. For instance, although the radar sensor 105b is said to have a field of view greater than that of the camera 105a, the reverse may be true.

The system may contain more than one radar sensor 105b or more than one camera 105a or both. The radar sensor 105b could be based on ultrasound technology.

In a further embodiment, it is not necessary to keep both sensors 105a, 105b active at all times. In order to save energy, one sensor can be turned on as soon as the other detects movement or presence. For example, the radar sensor 105b may monitor the surroundings of the terminal 100 with a relatively low duty cycle (short on-time with a longer off-time) and once it detects movement, the controller 106 may turn the camera 105a on, or vice versa. Furthermore, both the radar sensor 105b and the camera may be activated e.g. by sound/voice. Power consumption can also be minimized by designing the usage of the camera 105a and radar sensors 105b for each application so that they are active only when needed.

Further, it is possible to use components from certain communications radios as sensing radios, effectively radar. Examples include Bluetooth and Wi-Fi components.

Further still, in the above embodiments, although the camera 105a and radar sensor 105b are described as components integrated within the terminal 100, in alternative embodiments one or both types of sensor may be provided as separate accessories which are connected to the terminal by wired or wireless interfaces, e.g. USB or Bluetooth. The gesture control module 130 comprises the processor and gesture control module 130 for receiving and interpreting the information from the or each accessory.

Moreover, the disclosure of the present application should be understood to include any novel features or any novel combination of features either explicitly or implicitly disclosed herein or any generalization thereof and during the prosecution of the present application or of any application derived therefrom, new claims may be formulated to cover any such features and/or combination of such features.

1. (canceled)

2. Apparatus according to claim 22, wherein the computer-readable code stored when executed controls the at least one processor to respond to detecting an object outside of the overlapping zone to control a second, different, user interface function in accordance with a signal received from only one of the sensors.

3. Apparatus according to claim 22, wherein the computer-readable code stored when executed controls the at least one processor to respond to detecting an object inside the overlapping zone to identify from signals received from both sensors one or more predetermined gestures based on detected movement of the object, and to control the first user interface function in accordance with each identified gesture.

4. Apparatus according to claim 22, wherein the first sensor is an optical sensor and the second sensor senses radio waves received using a different part of the electromagnetic spectrum, and optionally is a radar sensor.

5. Apparatus according to claim 4, further comprising an image processor associated with the optical sensor, the image processor being configured to identify image signals received from different regions of the optical sensor, and wherein computer-readable code stored when executed controls the at least one processor configured to control different respective user interface functions dependent on the region in which an object is detected.

6. Apparatus according to claim 4, wherein the radar sensor is configured to emit and receive radio signals in such a way as to define a wider spatial sensing zone than a spatial sensing zone of the optical sensor.

7. Apparatus according to claim 22, wherein the computer-readable code stored when executed controls the at least one processor configured-to identify, from the received image and radio sensing signals, both a translational and a radial movement and/or radial distance for an object with respect to the apparatus and to determine therefrom the one or more predetermined gestures for controlling the first user interface function.

8. Apparatus according to claim 7, wherein the computer-readable code stored when executed controls the at least one processor configured to identify, from the received image signal, a motion vector associated with the foreground object's change of position between subsequent image frames and to derive therefrom the translational movement.

9. Apparatus according to claim 22, wherein the apparatus is a mobile communications terminal.

10. Apparatus according to claim 9, wherein the mobile communications terminal comprises a display on one side or face thereof for displaying graphical data controlled by means of signals received from both the first and second sensors.

11. Apparatus according to claim 9, wherein the first sensor is an optical sensor and the second sensor senses radio waves received using a different part of the electromagnetic spectrum, and optionally is a radar sensor and wherein the optical sensor is a camera provided on the same side or face as the display.

12. Apparatus according to claim 11, wherein the radar sensor is configured to receive reflected radio signals from the same side or face as the display.

13. Apparatus according to claim 22, wherein the computer-readable code stored when executed controls the at least one processor to detect a hand-shaped object.

14. A method comprising:
receiving signals from first and second sensors, the first and second sensors having respective first and second object sensing zones and providing a third, overlapping, zone in which both the first and second sensors can detect a common object, and
in response to detecting an object in the overlapping zone, controlling a first user interface function in accordance with the signals received from both sensors.

15. A method according to claim 14, further comprising receiving, in response to detecting an object outside of the overlapping zone, a signal from only one of the sensors; and controlling a second, different, user interface function in accordance with said received signal.

16. A method according to claim 15, further comprising receiving, in response to detecting an object outside of the overlapping zone, a signal from only the second sensor; and controlling a third, different, user interface function in accordance with said received signal.

18. A method according to claim 15, comprising identifying from signals received from both sensors one or more predetermined gestures based on detected movement of the object, and controlling the first user interface function in accordance with the or each identified gesture.

19. A method according to claim 15, comprising identifying image signals received from different regions of an optical sensor, and controlling different respective user interface functions dependent on the region in which an object is detected.

20. (canceled)

21. A non-transitory computer-readable storage medium having stored thereon computer-readable code, which, when executed by computing apparatus, causes the computing apparatus to perform a method comprising:
receiving signals from first and second sensors, the first and second sensors having respective first and second object sensing zones and providing a third, overlapping, zone in which both the first and second sensors can detect a common object, and
in response to detecting an object in the overlapping zone, controlling a first user interface function in accordance with the signals received from both sensors.

22. Apparatus, the apparatus having at least one processor and at least one memory having computer-readable code stored thereon which when executed controls the at least one processor:
to receive signals from first and second sensors, the first and second sensors having respective first and second object sensing zones and providing a third, overlapping, zone in which both the first and second sensors can detect a common object, and
to respond to detecting an object in the overlapping zone by controlling a first user interface function in accordance with the signals received from both sensors.
